(19) United States
(12) Patent Application Publication
(10) Pub. No.: US 2018/0065279 A1
(43) Pub. Date: Mar. 8, 2018

(54) DISPENSER, DISPENSER UNIT, AND APPARATUS FOR FORMING THREE-DIMENSIONAL OBJECT USING THE SAME

(71) Applicant: MIMAKI ENGINEERING CO., LTD., Nagano (JP)

(72) Inventor: Yasunori YAMAZAKI, Nagano (JP)

(73) Assignee: MIMAKI ENGINEERING CO., LTD., Nagano (JP)

(21) Appl. No.: 15/693,487

(22) Filed: Sep. 1, 2017

(30) Foreign Application Priority Data
Sep. 8, 2016 (JP) 2016-175987

(51) Int. Cl. B29C 39/02; B29C 39/44; B29C 35/02

(52) U.S. Cl. CPC B29C 39/02; B29C 35/02; B29C 39/44

(57) ABSTRACT

A dispenser includes a high-pressure liquid feeder that feeds a high-pressure liquid higher in pressure than atmospheric pressure, a discharger that discharges the high-pressure liquid fed from the high-pressure liquid feeder, and a drive source that drives the discharger to operate. The discharger includes at least a container in which the high-pressure liquid is containable, a rotor rotatable by the drive source, a casing in which the rotor is housed in a rotatable manner, and a controller configured to control rotation of the drive source and a position of the container in a direction of the rotation. The container is formed on an outer peripheral surface of the discharger. The casing has a liquid supply channel formed to intercommunicate the container and the high-pressure liquid feeder, and further has a discharge nozzle formed to intercommunicate the container and outside of the discharger.

### CROSS REFERENCE TO RELATED APPLICATIONS

This application claims the priority benefit of Japanese Patent Application No. 2016-175987, filed on Sep. 8, 2016. The entirety of the above-mentioned patent application is hereby incorporated by reference herein and made a part of this specification.

### TECHNICAL FIELD

This disclosure relates to a dispenser and a dispenser unit, and an apparatus for forming a three-dimensional object using the dispenser or the dispenser unit.

### DESCRIPTION OF THE BACKGROUND ART

Apparatuses leveraging the inkjet printing technique are increasingly used in diverse applications. A known example of such apparatuses is 3D printers configured to discharge a modeling material from an inkjet head to form a three-dimensional object. In the 3D printer, a liquid modeling material is discharged and irradiated with ultraviolet light to be cured, and the material thus cured is stacked in multiple layers to obtain a three-dimensional object having a desired shape (for example, Japanese Unexamined Patent Publication No. 2016-7711).

As is known in the art, there are constraints on the viscosity of liquid materials that can be discharged from the inkjet head. There have been various attempts to improve the inkjet head to allow for discharge of high-viscosity inks. Japanese Unexamined Patent Publication No. 2013-103460, for instance, describes an inkjet head driving method aimed at optimizing the timing of applying a drive pulse. In the inkjet head driving method described in Japanese Unexamined Patent Publication No. 2013-103460, a first drive pulse is used to discharge an ink from an inkjet head, and a second drive pulse is used to break stringiness of the ink. According to this method, inks higher in viscosity than in the known art may be discharged from the inkjet head.

Patent Literature 1: Japanese Unexamined Patent Publication No. 2016-7711

Patent Literature 2: Japanese Unexamined Patent Publication No. 2013-103460

### SUMMARY

The inkjet head driving method described in Japanese Unexamined Patent Publication No. 2013-103460, however, only allows the inkjet head to discharge inks having a degree of viscosity up to 50 mPa·S. This method inevitably thus failing to deal with any inks higher in viscosity than 50 mPa·S can only use a limited number of inks.

To address the issue of the known art, this disclosure is directed to providing a dispenser and a dispenser unit that may successfully discharge high-viscosity liquids, and an apparatus for forming a three-dimensional object using the dispenser or the dispenser unit.

A dispenser disclosed herein includes: a high-pressure liquid feeder that feeds a high-pressure liquid higher in pressure than atmospheric pressure; a discharger that discharges the high-pressure liquid fed from the high-pressure liquid feeder; and a drive source that drives the discharger to operate. The discharger includes at least a container in which the high-pressure liquid is containable. The container is formed on an outer peripheral surface of the discharger. The discharger further includes a rotor rotatable by the drive source, a casing in which the rotor is housed in a rotatable manner, and a controller configured to control rotation of the drive source and a position of the container in a direction of the rotation of the drive source. The casing has a liquid supply channel formed to intercommunicate the container and the high-pressure liquid feeder, and further has a discharge nozzle formed to intercommunicate the container and outside of the discharger.

In the dispenser, the high-pressure liquid feeder feeds the container with the high-pressure liquid. Then, the high-pressure liquid may be discharged out of the container by a pressure difference between pressures in the container's inside and outside of the discharge nozzle when the rotor is rotated and the container and the discharge nozzle are accordingly intercommunicated. The high-pressure liquid may be subject to a centrifugal force generated by the rotation of the rotor in the liquid-discharge direction, and gravity in the liquid-discharge direction (vertically downward) may increase the action of a force in the liquid-discharge direction. As a result, the high-pressure ink increased in viscosity may successfully be discharged.

According to an aspect, the dispenser may further include a phase sensor that measures a rotational phase of the drive source, and the controller may control the rotation of the drive source based on a result of detection by the phase sensor to control the position of the container.

The dispenser may avoid the event that the drive source ceases to rotate while the container and the discharge nozzle are still communicating with each other. Then, any liquid adhered to the container's inner wall may be prevented from being exposed to the atmosphere while the drive source is inactive, and the solvent of the ink adhered to the container's inner wall may be unlikely to volatilize. As a result, the ink may be prevented from unremovably adhering to the container's interior.

According to an aspect, the dispenser may further include a temperature adjuster that adjusts a temperature of a surface of the container that makes contact with the high-pressure liquid.

In the dispenser, the container's inner wall may have a temperature adjusted to be near or equal to a target temperature. This may suppress possible changes of wettability on the container's inner wall and thereby decrease variability in quantity of any liquid adhered to the container's inner wall when the high-pressure liquid is discharged from the container. As a result, variability in quantity of the liquid that can be discharged from the container may be reduced.

According to an aspect, the drive source may be a stepping motor or a servo motor.

Such a drive source may allow for rotation control in accordance with its rotational phase. This may avoid the event that the drive source ceases to rotate while the container and the discharge nozzle are still communicating with each other. Then, any liquid adhered to the container's inner wall may be prevented from being exposed to the atmosphere, and may be accordingly prevented from unremovably adhering to the container's interior. The rotation of the drive source may be temporarily ceased every time when the container and the discharge nozzle are intercommunicated, and the container and the discharge nozzle may certainly be intercommunicated until after the high-pressure liquid in the container is discharged through the discharge nozzle. Thus, the container and the discharge nozzle may continue to communicate with each other until the internal pressure of the container equals to the atmospheric pressure, and the whole liquid in the container may be completely drained. This may stabilize a dischargeable liquid quantity of the container.

To address the issue of the known art, this disclosure is further directed to providing a dispenser unit including a plurality of the dispensers according to any one of the aspects. A plurality of the dischargers in the plurality of the dispensers are coupled to the drive source.

This dispenser unit is structured to discharge the liquid from the plural dischargers at once by rotating one drive source.

According to an aspect, the dispenser unit may further include electromagnetic valves attached to the liquid supply channels in the plurality of the dispensers, and the controller may open and close the electromagnetic valves to control feed of the ink to the plurality of the dispensers.

The dispenser unit may block the high-pressure liquid that flows out of the high-pressure liquid feeders into the dischargers. Any leakage of the liquid from the dischargers may be accordingly suppressed. By opening and closing the electromagnetic valves, the dischargers may be selectively allowed to discharge the liquid.

To address the issue of the known art, this disclosure is further directed to providing an apparatus for forming a three-dimensional object, including: the dispenser according to any one of the aspects; a table on which the three-dimensional object is formable; an ultraviolet light source that irradiates the three-dimensional object with ultraviolet light; and a driver that moves the table and the dispenser relative to each other. The controller controls operation of the driver and rotation of the drive source based on shape-related information of the three-dimensional object.

This disclosure is further directed to providing an apparatus for forming a three-dimensional object, including: the dispenser unit according to one of the aspects; a table on which the three-dimensional object is formable; an ultraviolet light source that irradiates the three-dimensional object with ultraviolet light; and a driver that moves the table and the dispenser relative to each other. The controller controls operation of the driver and rotation of the drive source based on shape-related information of the three-dimensional object.

The dispenser and the dispenser unit, and the three-dimensional object forming apparatus using the dispenser or the dispenser unit may ensure successful discharge of high-viscosity liquids.

### BRIEF DESCRIPTION OF THE DRAWINGS

FIG. 1 is a schematic drawing of an apparatus for forming a three-dimensional object according to a first embodiment.

FIG. 2 is an exemplary perspective view of a three-dimensional object formed by the three-dimensional object forming apparatus illustrated in FIG. 1.

FIG. 3 is a drawing of a dispenser unit according to the first embodiment viewed from the side of its ink-discharge surface.

FIG. 4 is a front view of a dispenser according to the first embodiment.

FIG. 5 is a side view of the dispenser according to the first embodiment.

FIG. 6 is a cross-sectional view of FIG. 4 taken along line A-A.

FIG. 7 is a cross-sectional view of FIG. 5 taken along line B-B when a container in the dispenser according to the first embodiment is communicating with a discharge nozzle.

FIG. 8 is a cross-sectional view of FIG. 5 taken along line B-B when the container in the dispenser according to the first embodiment is not communicating with the discharge nozzle.

FIG. 9 is a schematic cross-sectional view of a modified example of the container in the dispenser.

FIG. 10 is a schematic block diagram of a dispenser unit according to a second embodiment.

### DETAILED DESCRIPTION OF EMBODIMENTS

Hereinafter, embodiments of a dispenser and a dispenser unit, and an apparatus for forming a three-dimensional object using the dispenser or the dispenser unit, which are disclosed herein, are described in detail referring to the accompanying drawings. It should be understood that the scope of this disclosure is not limited by the embodiments, and description of the embodiments may include structural and technical features that are replaceable by those skilled in the art, easily available, or substantially identical.

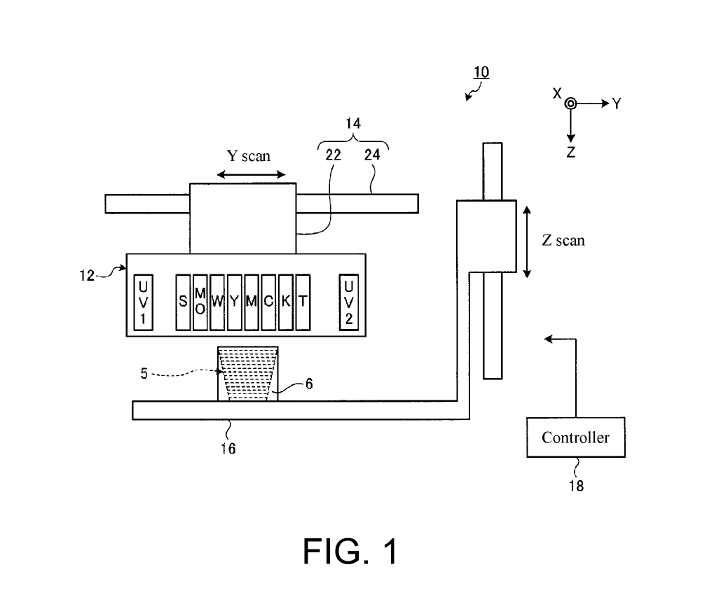

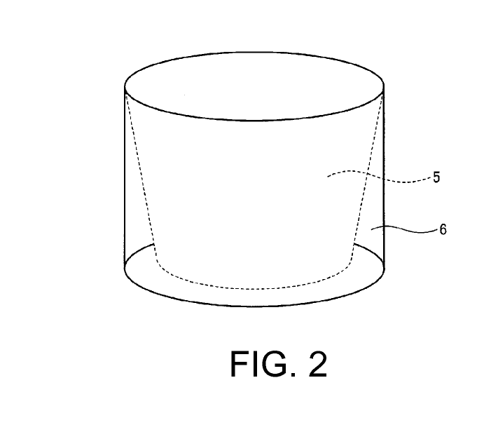

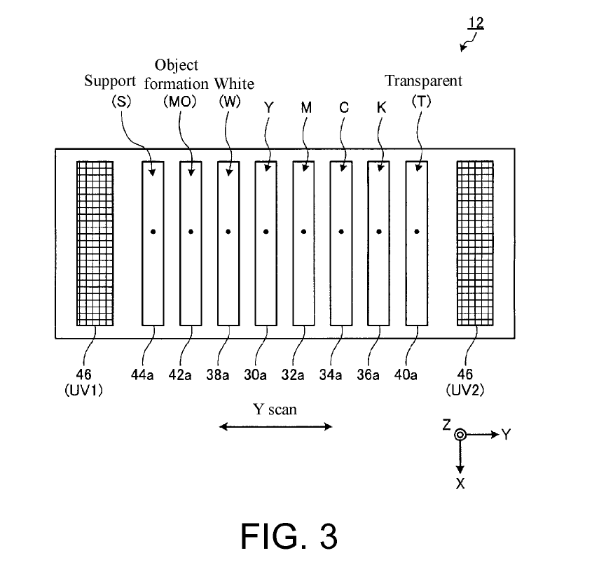

FIG. 1 is a schematic drawing of a three-dimensional object forming apparatus 10 according to a first embodiment. FIG. 2 is an exemplary perspective view of a three-dimensional object 5 formed by the three-dimensional object forming apparatus 10 illustrated in FIG. 1. FIG. 3 is a drawing of a dispenser unit 12a according to the first embodiment viewed from the side of its ink-discharge surface. The three-dimensional object forming apparatus 10 illustrated in FIG. 1 forms the three-dimensional object 5 by lamination technique. The lamination technique described here forms the three-dimensional object 5 by three-dimensionally stacking a plurality of layers on one another. The three-dimensional object forming apparatus 10 may employ a color object forming method for forming a three-dimensional object in colors using shape-related information of the three-dimensional object and color image-related information.

The three-dimensional object forming apparatus 10 may be configured identically or similarly to the known apparatuses of the same kind except the technical features hereinafter described. The three-dimensional object forming apparatus 10 may be a partly modified, known inkjet printer configured for two-dimensional printing. The three-dimensional object forming apparatus 10 may be a partly modified, known inkjet printer that uses ultraviolet-curable inks (UV inks).

The three-dimensional object forming apparatus 10 according to the first embodiment has a dispenser unit 12a, a main scan driver 14, a table 16 on which the three-dimensional object 5 will be formed, and a controller 18. The dispenser unit 12a is a device of the apparatus that discharges droplets of a liquid material that forms the three-dimensional object 5. Specifically, the dispenser unit 12a discharges resin droplets that are curable under predetermined conditions, and cures the discharged droplets to form layers of the three-dimensional object 5. Specifically, the dispenser unit 12a may discharge the droplets as prompted by the controller 18 to repeatedly form and cure multiple layers of the curable resin and stack the cured resin layers on one another.

The curable resin, material of the three-dimensional object 5, may be an ultraviolet-curable resin cured by ultraviolet irradiation. In this instance, droplets of an ultraviolet-curable ink are discharged from the dispenser unit 12a, and layers of the ultraviolet-curable ink are cured by being irradiated with ultraviolet light emitted from ultraviolet light sources 46.

In a case where a colored three-dimensional object 5 is obtained by the three-dimensional object forming apparatus 10 according to the first embodiment, the dispenser unit 12a discharges droplets of a colored ultraviolet-curable ink to color the surface or the interior of the three-dimensional object 5. As illustrated in FIG. 2, the dispenser unit 12a forms a support 6 around the three-dimensional object 5 during the process to form this object. The support 6 is a layered structure (formed by support layers) that supports the three-dimensional object 5 currently formed. The support 6 is dissolved with water and removed after the three-dimensional object 5 is finally obtained. The operation and specifics of the dispenser unit 12a will be described later in further detail.

The main scan driver 14 drives the dispenser unit 12a to perform main scans. In the first embodiment, the driving the dispenser unit 12a to perform main scans may be specifically driving a dispenser 30a of the dispenser unit 12a to perform main scans. The main scan may be specifically an operation in which the dispenser 30a discharges ink droplets while moving in a preset main scanning direction (Y direction on the drawing).

The main scan driver 14 has a carriage 22 and a guide rail 24. The carriage 22 is a holder in which the dispenser unit 12a is held so as to face the table 16. That is, the carriage 22 holds the dispenser unit 12a, so that the ink droplets discharged from the dispenser unit 12a are directed toward the table 16. In the main scans, the carriage 22 holding the dispenser unit 12a moves along the guide rail 24. The guide rail 24 guides the movement of the carriage 22. In the main scans, the guide rail 24 moves the carriage 22 as prompted by the controller 18.

The movement of the dispenser unit 12a during the main scans may include a relative displacement of the dispenser unit 12a to the three-dimensional object 5. In a modified example of the three-dimensional object forming apparatus 10, for example, the dispenser unit 12a may be located at a position, and the table 16 may be moved to move the three-dimensional object 5.

On the upper surface of the table 16, the three-dimensional object 5 will be formed. The upper surface of the table 16 is movable upward and downward (Z direction on the drawing). As prompted by the controller 18, the upper surface of the table 16 moves in this direction depending on the ongoing progress of the three-dimensional object 5. This may suitably adjust a distance (gap) between the dispenser unit 12a and a target surface of the three-dimensional object 5 currently formed. The target surface of the three-dimensional object 5 is a surface on which a next layer will be formed by the dispenser unit 12a. The upper surface of the table 16 is further movable in a sub scanning direction (X direction on the drawing). As prompted by the controller 18, the upper surface of the table 16 moves in this direction depending on the ongoing progress of the three-dimensional object 5. Instead of moving the table 16 relative to the dispenser unit 12a in the Z, X, and Y directions, the dispenser unit 12a may be moved in the Z, X, and Y directions.

The controller 18 controls the structural elements of the three-dimensional object forming apparatus 10. The controller 18 includes a CPU (Central Processing Unit) configured to execute different processes, a RAM (Random Access Memory) in which various pieces of information are stored, and a ROM (Read Only Memory). The controller 18 controls the respective elements of the three-dimensional object forming apparatus 10 based on color image-related information and shape-related information of the three-dimensional object 5 desirably obtained. The controller 18 thus controls the operation to form the three-dimensional object 5.

FIG. 3 is a drawing of the dispenser unit 12a viewed from the side of its ink-discharge surface. The dispenser unit 12a includes dispensers 30a, 32a, 34a, 36a, 38a, 40a, 42a, and 44a, and ultraviolet light sources 46.

A respective one of the dispensers 30a, 32a, 34a, 36a, 38a, 40a, 42a, and 44a discharges curable resin droplets. Specifically, a respective one of the dispensers 30a, 32a, 34a, 36a, 38a, 40a, 42a, and 44a discharges droplets of ultraviolet-curable inks. The dispensers 30a, 32a, 34a, 36a, 38a, 40a, 42a, and 44a are arranged in the main scanning direction (Y direction) in positional alignment with one another in the sub scanning direction (X direction).

Specifically, the dispensers 30a, 32a, 34a, and 36a discharge droplets of ultraviolet-curable inks in different colors, for example, yellow (Y), magenta (M), cyan (C), and black (K). The dispenser 38a discharges droplets of a white (W) ultraviolet-curable ink.

The dispenser 40a discharges droplets of an ultraviolet-curable clear ink. The clear ink is a colorless, transparent (T) ink. The clear ink contains a colorant-less ink containing an ultraviolet-curable resin.

The dispenser 42a is an inkjet head that discharges droplets of an ultraviolet-curable ink; a flowable material, to form the three-dimensional object 5. The dispenser 42a is allowed to discharge droplets of a modeling ink (MO) having a predetermined color. Examples of the modeling ink may be a white ink and a clear ink.

The dispenser 44a discharges ink droplets including a material (S) of the support 6 (see FIG. 2). The material of the support 6 may be a water-soluble material that can be dissolved away in water after the three-dimensional object 5 is completed, or may be a suitable one selected from the known materials for such a support.

Specifics of the dispensers 30a, 32a, 34a, 36a, 38a, 40a, 42a, and 44a will be described later.

The ultraviolet light sources 46 radiate ultraviolet light to cure the ultraviolet-curable inks. Examples of the ultraviolet light source 46 may be ultraviolet LED (Light Emitting Diode), metal halide lamps, and mercury lamps. In the three-dimensional object forming apparatus 10 according to the first embodiment, UV1 and UV2 are the ultraviolet light sources 46. The UV1 is disposed on one end side of the dispenser unit 12a in the main scanning direction (Y direction). The UV2 is disposed on the other end side of the dispenser unit 12a in the main scanning direction (Y direction).

The three-dimensional object forming apparatus 10 according to the first embodiment has configuration as described above. The operation of the three-dimensional object forming apparatus 10 is now described. In forming the three-dimensional object 5 with the three-dimensional object forming apparatus 10, object-forming data of the three-dimensional object 5 is obtained by the controller 18 from an external device such as a personal computer (not illustrated in the drawings), and the dispenser unit 12a is controlled by the controller 18 based on the obtained data to form the three-dimensional object 5 on the table 16. In this data used to form the three-dimensional object 5, the three-dimensional object 5, which will be formed, is divided in the Z direction into multiple parts and handled as multiple layers, and ink-discharge positions in the main and sub scanning directions in each of the multiple layers are defined for each ink. To form the three-dimensional object 5 using the dispenser unit 12a, the ink droplets are discharged from the dispenser unit 12a based on the object-forming data to form layers in the Z direction, and the ink droplets discharged for each layer are irradiated with ultraviolet light from the ultraviolet light sources 46 and thereby cured. The three-dimensional object forming apparatus 10 repeatedly discharges and cures the ink droplets using the discharge unit 12a to form the three-dimensional object 5.

To discharge the ink droplets from the dispenser unit 12a, the controller 18 prompts the main scan driver 14 to move the carriage 22 along the guide rail 24 in the main scanning direction (Y direction). Thus, the dispenser unit 12a, while moving in the main scanning direction, discharges the ink droplets. After the table 16 is moved in the sub scanning direction (X direction), the ink droplets are repeatedly discharged in the main scanning direction (Y direction). The dispenser unit 12a thus discharges the ink droplets to positions defined by the object-forming data in the main scanning direction (Y direction) and in the sub scanning direction (X direction).

Among the dispensers 30a, 32a, 34a, 36a, 38a, 40a, 42a, and 44a of the dispenser unit 12a, the dispensers 30a, 32a, 34a, and 36a discharge the colored ink droplets used to color the three-dimensional object 5. The object-forming data includes coloring-related data for the three-dimensional object 5. The dispensers 30a, 32a, 34a, and 36a discharge the colored ink droplets based on the coloring-related data.

The dispenser 38a discharges the white ink droplets to an inner part of the three-dimensional object 5 than parts of this object colored with the inks discharged from the dispensers 30a, 32a, 34a, and 36a. As a result, the three-dimensional object 5 is presented in vivid colors produced by subtractive color mixing as in a two-dimensionally printed image on a white piece of paper.

To give luster to the outermost surface of the three-dimensional object 5 for aesthetic purposes, the dispenser 40a may discharge transparent ink droplets to the outer side of the three-dimensional object 5, which will be the outermost surface of this object, than the outer side of the colored ink-discharged parts.

The dispenser 42a discharges ink droplets of a base material for the three-dimensional object 5. The dispenser 42a discharges ink droplets of the base material based on the object-forming data to shape a part of the three-dimensional object 5 in each layer. At that time, the dispensers 30a, 32a, 34a, 36a, 38a, and 40a discharge the ink droplets in different colors to color the layers of the base material as predefined in the object-forming data.

To form the three-dimensional object 5 with high accuracy in any optional shape, the dispenser 44a discharges ink droplets of a material for the support 6 in any parts of the layers but parts constituting the three-dimensional object 5. In a respective one of the layers, the ink droplets for the support 6 serve to retain the shape of the three-dimensional object 5 even before the inks are cured.

The controller 18 prompts the dispenser unit 12a to discharge the ink droplets for each layer based on the object-forming data while moving the dispenser unit 12a and the table 16 relative to each other in the main and sub scanning directions, and then prompts the ultraviolet light sources 46 to radiate ultraviolet light to cure the inks. After one layer is thus formed, the table 16 moves away from the dispenser unit 12a in the Z direction by a dimension equal to a thickness of one layer. Then, the dispenser unit 12a overlays a next layer on the cured previous layer in the Z direction. The three-dimensional object forming apparatus 10 repeatedly forms the layers as described so far to form the three-dimensional object 5.

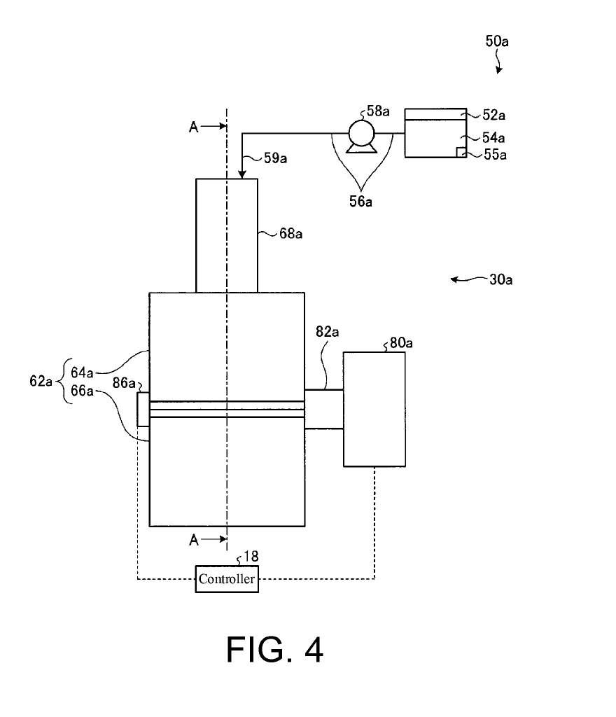

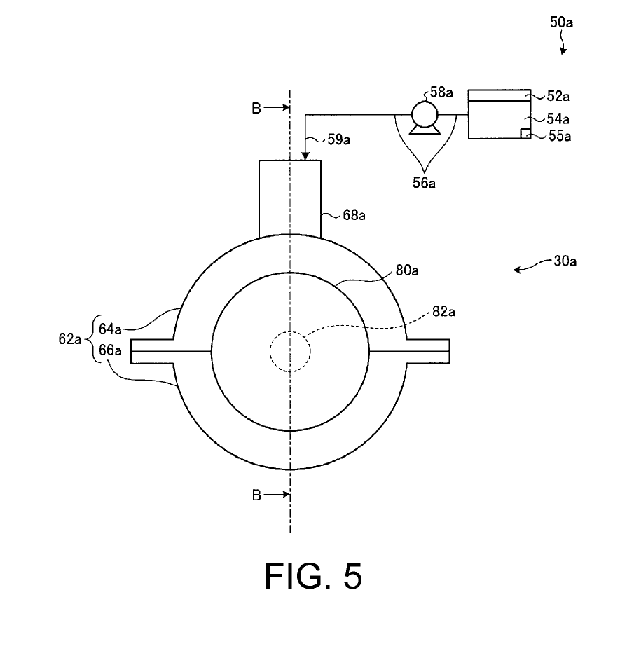

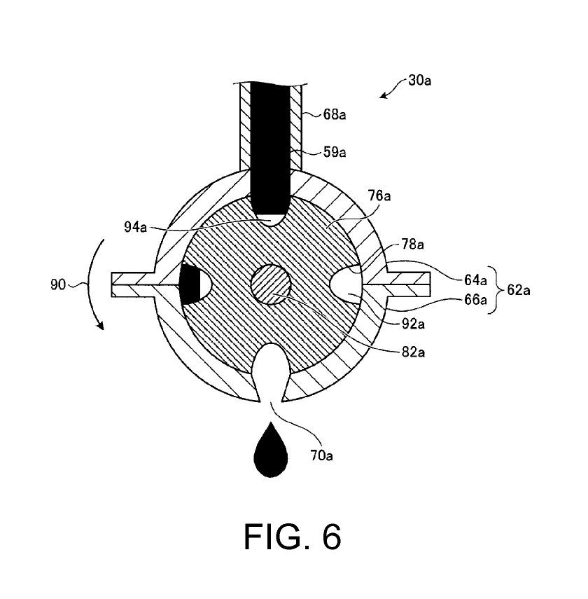

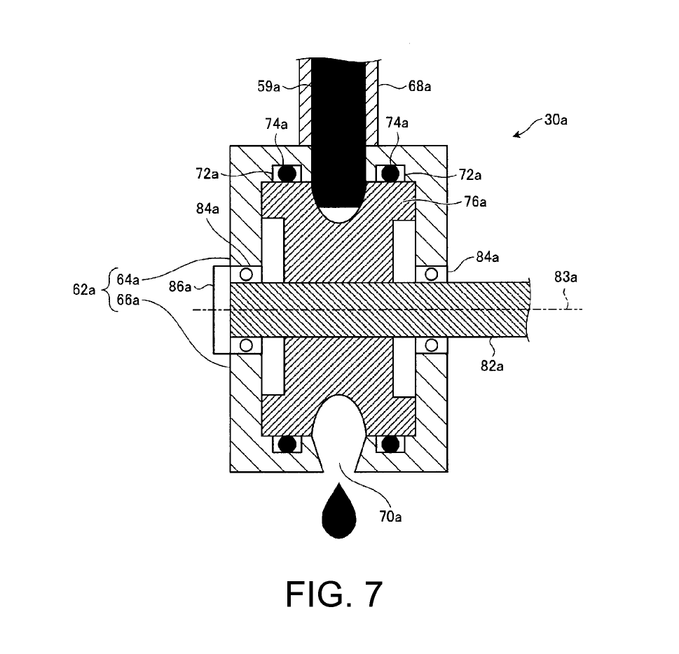

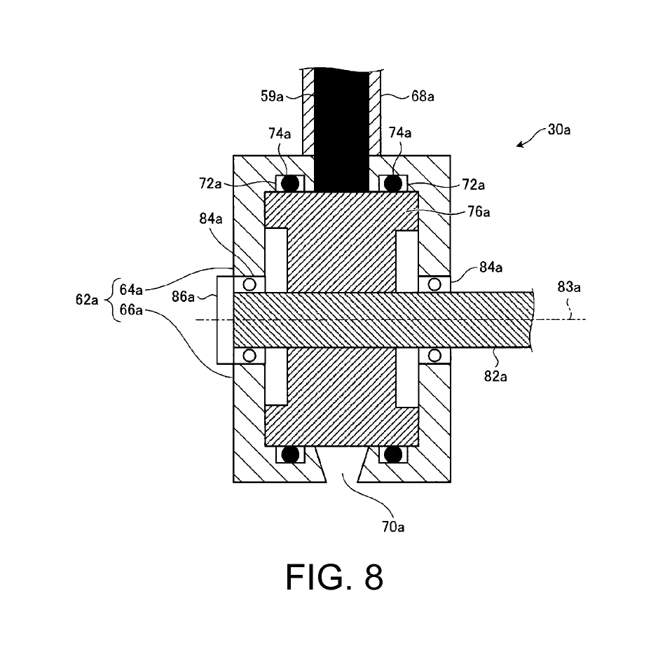

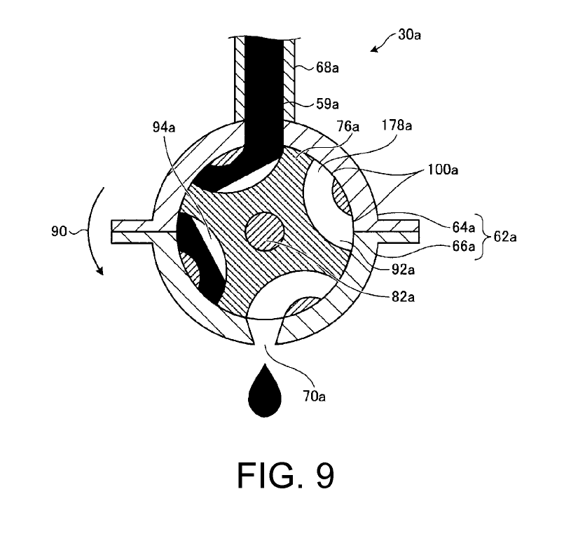

Referring to FIGS. 3, 4, 5, 6, 7, 8, and 9, the dispenser 30a according to the first embodiment is described below. FIG. 4 is a front view of the dispenser 30a according to the first embodiment. FIG. 5 is a side view of the dispenser 30a according to the first embodiment. FIG. 6 is a cross-sectional view of FIG. 4 taken along line A-A. FIG. 7 is a cross-sectional view of FIG. 5 taken along line B-B when a container 78a in the dispenser 30a according to the first embodiment is communicating with a discharge nozzle 70a. FIG. 8 is a cross-sectional view of FIG. 5 taken along line B-B when the container 78a in the dispenser 30a according to the first embodiment is not communicating with the discharge nozzle 70a. FIG. 9 is a schematic cross-sectional view of a modified example of the containers in the dispenser 30a.

The dispensers 32a, 34a, 36a, 38a, 40a, 42a, and 44a, which are similar to the dispenser 30a except the inks used therein, will not be described herein.

The dispenser 30a has a high-pressure liquid feeder 50a, a discharger 60a, a motor 80a which is a drive source that feeds a rotary drive power, bearings 84a, and a phase sensor 86a.

The high-pressure liquid feeder 50a includes an ink tank 52a, an ink 54a, a temperature adjuster 55a, an ink flow path 56a, and a pump 58a. The high-pressure liquid feeder 50a feeds a high-pressure ink 59a. The ink tank 52a is a vessel in which the ink 54a is stored. The ink 54a may be an ultraviolet-curable ink. As illustrated in FIG. 4, the temperature adjuster 55a is disposed in the ink tank 52a. The temperature adjuster 55a may have a heater for heating the ink 54a, and a heater controller for ON/OFF control of the heater depending on a current temperature of the ink 54a. The temperature adjuster 55a turns on or off the heater, so that the ink 54a is as close as possible to a preset target temperature. The heater controller of the temperature adjuster 55a turns on the heater when the temperature of the ink 54a is lower than the preset target temperature. The heater controller of the temperature adjuster 55a turns off the heater when the temperature of the ink 54a is higher than the preset target temperature. In this embodiment, the heater controller of the temperature adjuster 55a turns on and off the heater to adjust the temperature of the ink 54a. Instead, the temperature of the ink 54a may be adjusted by the temperature adjuster 55a by PID control means. The ink flow path 56a is a flow path for the ink 54a. The ink flow path 56a couples the ink tank 52a to a casing 62a through the pump 58a. An example of the ink flow path 56a is a pressure hose. The inlet side of the pump 58a is coupled to the ink tank 52a through the ink flow path 56a. The outlet side of the pump 58a is coupled to the casing 62a through the ink flow path 56a. The pump 58a may increase the pressure of the ink 54a contained in the ink tank 52a to 6 ATM (0.60795 MPa). A high-pressure ink 59a thus obtained is pumped by the pump 58a into the casing 62a. In this embodiment, 6 TM is the pressure of the high-pressure ink 59a pumped by the pump 58a into the casing 62a. This value of pressure is, however, a non-limiting example. The high-pressure ink 59a pumped out by the pump 58a may desirably have a pressure higher than the atmospheric pressure, which may be obtained through appropriate adjustments depending on conditions set for discharge of this ink.

The discharger 60a has a casing 62a, O-rings 74a, and a rotor 76a.

The casing 62a is a columnar vessel having a hollow interior. The rotor 76a is housed in the casing 62a. As illustrated in FIG. 4, the casing 62a is dividable into an upper casing 64a and a lower casing 66a. The casing 62a, however, may be divided otherwise. The upper casing 64a may be immovably fixed with screws to the lower casing 66a. As illustrated in FIG. 6, the upper casing 64a has a liquid supply channel 68a formed on its vertically upper side. The liquid supply channel 68a is coupled to the ink flow path 56a. As illustrated in FIG. 6, the lower casing 66a has a discharge nozzle 70a formed on its vertically lower side. The discharge nozzle 70a discharges the high-pressure ink 59a supplied from the rotor 76a. The discharge nozzle 70a is formed to allow the ink to be discharged vertically downward. As illustrated in FIG. 7, the casing 62a has sealing grooves 72a formed along its inner peripheral surface. As illustrated in FIG. 7, the sealing grooves 72a are parallel to each other across the liquid supply channel 68a and the discharge nozzle 70a interposed therebetween.

The O-rings 74a are sealing members that fill a gap between the casing 62a and the rotor 76a to enclose the high-pressure ink 59a. As illustrated in FIG. 7, the O-rings 74a are fitted in the sealing grooves 72a.

The rotor 76a has a columnar shape. As illustrated in FIG. 6, the rotor 76a is rotatably housed in the casing 62a and is secured to a shaft 82a of the drive source; motor 80a. Specifically, the rotor 76a is secured to the shaft 82a in a manner that the center axis of the rotor 76a coincides with an axis of rotation 83a of the shaft 82a. When the motor 80a rotates the shaft 82a, the rotor 76a rotates integral with the shaft 82a. The rotor 76a has four containers 78a in which the high-pressure ink 59a is containable. As illustrated in FIG. 6, the four containers 78a are formed at circumferentially equal intervals on the outer peripheral surface of the rotor 76a, i.e., the containers 78a are formed at positions shifted from one another through 90 degrees on the outer peripheral surface of the rotor 76a. The four containers 78a are specifically recesses each having an opening toward the outer peripheral surface of the rotor 76a. As illustrated in FIGS. 6 and 7, the four containers 78a have a semi-spherical shape and have an equal volume. As illustrated in FIG. 7, the containers 78a are formed at positions that allow for communication with the liquid supply channel 68a and the discharge nozzle 70a when the rotor 76a is rotated.

The motor 80a is an electrically driven motor and is coupled to the controller 18. The motor 80a has a shaft 82a. As illustrated in FIG. 7, the rotor 76a is secured to the shaft 82a. The shaft 82a rotates on the axis of rotation 83a. As illustrated in FIG. 7, the shaft 82a is inserted in the casing 62a.

The bearings 84a rotatably support the shaft 82a. An example of the bearing 84a is a ball bearing. The bearings 84a are interposed between the casing 62a and the shaft 82a.

The phase sensor 86a measures the phase of the motor 80a. As illustrated in FIG. 7, the phase sensor 86a is disposed at an end of the shaft 82a. The phase sensor 86a outputs data of the measured phase to the controller 18. The phase sensor 86a disposed at an end of the shaft 82a in this embodiment may instead be disposed in the bearing(s) 84a or in the motor 80a in so far as the phase of the motor 80a is measurable.

The controller 18 is coupled to the motor 80a and the phase sensor 86a. The controller 18 rotates the motor 80a to have the dispenser 30a discharge the ink. In response to a phase signal inputted from the phase sensor 86a, the controller 18 controls a position at which the motor 80a ceases to rotate.

The operation of the dispenser 30a according to the first embodiment is hereinafter described. In the dispenser 30a according to this embodiment, the rotor 76a is rotated by the motor 80a around the shaft 82a. The rotor 76a rotates on the axis of rotation 83a in a direction indicated with arrow 90 in FIG. 6. The rate of rotation of the motor 80a may be 6,000 rpm. The temperature adjuster 55a turns on and off the heater, so that the ink 54a stored in the ink tank 52a is as close as possible to the preset target temperature. The pump 58a increases the pressure of the ink 54a stored in the ink tank 52a and discharges the high-pressure ink 59a. The pump 58a supplies the high-pressure ink 59a to the liquid supply channel 68a formed in the casing 62a. After the container 78a formed in the rotor 76a and the liquid supply channel 68a start to communicate with each other, the high-pressure liquid feeder 50a feeds the container 78a with the high-pressure ink 59a. The O-rings 74a seal the gap between the casing 62a and the rotor 76a to prevent the high-pressure ink 59a in the container 78a leaking out through the gap between the casing 62a and the rotor 76a. As illustrated in FIG. 6, the container 78a yet to be supplied with the high-pressure ink 59a is filled with normal-pressure air 92a. When the high-pressure liquid feeder 50a feeds the container 78a with the high-pressure ink 59a, the normal-pressure air 92a is compressed into high-pressure air 94a. In this embodiment, the pressure of the high-pressure ink 59a is 6 ATM, and the volume of the high-pressure air 94a is compressed to approximately one-sixth of the volume of the normal-pressure air 92a. As the rotor 76a is rotated, the high-pressure ink 59a in the container 78a flows downward toward the vertically lower side of the rotor 76a. After the container 78a and the discharge nozzle 70a start to communicate with each other, the high-pressure ink 59a is discharged out of the container 78a through the discharge nozzle 70a. The pressures of the high-pressure ink 59a in the container 78a and the high-pressure air 94a, and the atmospheric pressure differ from one another. Such differences in pressure, as well as a rotation-induced centrifugal force and gravity acting in the ink-discharge direction (vertically downward), push the high-pressure ink 59a out of the container 78a. During a 360-degree rotation of the rotor 76a, the dispenser 30a discharges the ink out of the four containers 78a. This means that the dispenser 30a has 400 Hz responsiveness to the discharge control when the rotor 76a is rotated at 6,000 rpm. The dispenser 30a is thus repeatedly operated to continue to discharge the ink.

The temperature adjuster 55a adjusts the temperature of the ink 54a to be as close as possible to the target temperature, and the high-pressure ink 59a is supplied to the container 78a at a temperature approximate to the target temperature. To suspend the ink-discharge operation of the dispenser 30a, the controller 18 suspends the rotation of the motor 80a. To prevent the motor 80a from ceasing to rotate while the container 78a and the liquid supply channel 68a are still communicating with each other, as illustrated in FIG. 7, the controller 18 controls positions at which the containers 78a cease to move in the direction of rotation. In a case where the controller 18 determines from a result of detection obtained by the phase sensor 86a that the container 78a and the liquid supply channel 68a are still intercommunicated, the controller 18 rotates the motor 80a to a position at which the container 78a and the discharge nozzle 70a no longer intercommunicate. A position of the rotor 76a illustrated in FIG. 8 may be an example of the position at which the container 78a and the discharge nozzle 70a no longer intercommunicate.

In the dispenser 30a according to the first embodiment, the containers 78a are formed on the outer periphery of the rotor 76a, and the container 78a reaches a position at which the liquid supply channel 68a and the discharge nozzle 70a are intercommunicated when the rotor 76a is rotated. Further, the high-pressure liquid feeder 50a feeds the container 78a with the high-pressure ink 59a, and the motor 80a rotates the rotor 76a around the shaft 82a. The discharge nozzle 70a is formed on the vertically lower side of the casing 62a. The high-pressure ink 59a may be supplied to the containers 78a by the high-pressure liquid feeder 50a, and then discharged out of the containers 78a by a pressure difference between inside of the container 78a and outside of the discharge nozzle 70a when the rotor 76a rotates and the container 78a and the discharge nozzle 70a are intercommunicated. The high-pressure ink 59a may be subject to a centrifugal force generated by the rotation of the rotor 76a in the direction of discharge of the high-pressure ink 59a, and gravity in the ink-discharge direction (vertically downward) may increase the action of a force in the ink-discharge direction of the high-pressure ink 59a. As a result, the high-pressure ink 59a increased in viscosity may successfully be discharged.

In the dispenser 30a according to the first embodiment, the upper casing 64a is immovably fixed with screws to the lower casing 66a, and the casing 62a is dividable into the upper casing 64a and the lower casing 66a. In the dispenser 30a thus structured, the rotor 76a is replaceable with another rotor with larger or smaller containers to allow the dispenser 30a to change its discharge quantity. This may facilitate maintenance of the dispenser 30a, for example, the rotor 76a may be easily removed in the case of blockage of the containers 78a, or the worn O-rings 74a may be replaced with new ones.

The dispenser 30a according to the first embodiment has the temperature adjuster 55a that turns on and off the heater, so that the ink 54a stored in the ink tank 52a is as close as possible to the preset target temperature. By using the temperature adjuster 55a, the temperature of the ink 54a stored in the ink tank 52a may be adjusted to be near or equal to the target temperature, and the temperature of the high-pressure ink 59a supplied to the containers 78a of the rotor 76a may be accordingly adjusted to be near or equal to the target temperature. Further, the inner walls of the containers 78a supplied with the high-pressure ink 59a may be adjusted in temperature to be near or equal to the target temperature. The inner wall of the container 78a refers to a surface of the container 78a that makes contact with the high-pressure ink 59a. This may suppress possible changes of wettability on the inner wall of the container 78a and thereby decrease variability in quantity of the high-pressure ink 59a from the container 78a possibly adhered to the inner wall of the container 78a. As a result, variability in quantity of the ink that can be discharged from the container 78a may be reduced.

The phase sensor 86a of the dispenser 30a according to the first embodiment measures phase-related information of the motor 80a and is coupled to the controller 18. When the controller 18 receives the rotational phase-related information of the motor 80a and suspends the rotation of the motor 80a, the dispenser 30a may be operable to prevent the motor 80a from ceasing to rotate while the container 78a and the discharge nozzle 70a are still communicating with each other. This may prevent that the ink adhered to the inner wall of the container 78a is exposed to the atmosphere after the motor 80a ceases to rotate. Then, the solvent of the ink adhered to the inner wall of the container 78a may be unlikely to volatilize. As a result, the ink may be prevented from unremovably adhering to the interior of the container 78a.

The dispenser 30a according to the first embodiment has four containers 78a fondled on the outer periphery of the rotor 76a. This may allow the ink to be discharged four times during a 360-degree rotation of the rotor 76a. The dispenser 30a may be allowed to discharge the ink 400 times per second when the rate of rotation of the motor 80a is 6,000 rpm. Thus, the dispenser 30a may improve in responsiveness to the discharge control.

The motor 80a may be a servo motor or a stepping motor. Such a motor may allow for rotation control in accordance with the rotational phase of the motor 80a. This may avoid the event that the motor 80a ceases to rotate while the container 78a and the discharge nozzle 70a are still communicating with each other. Then, any ink adhered to the inner wall of the container 78a may be prevented from being exposed to the atmosphere, and may be accordingly prevented from unremovably adhering to the interior of the container 78a. The rotation of the motor 80a may be temporarily suspended every time when the container 78a and the discharge nozzle 70a are intercommunicated, and the container 78a and the discharge nozzle 70a may continue to communicate with each other until after the high-pressure ink 59a in the container 78a is discharged through the discharge nozzle 70a. Thus, the container 78a and the discharge nozzle 70a may continue to communicate with each other until the internal pressure of the container 78a equals to the atmospheric pressure, and the whole ink in the container 78a may be completely drained. This may stabilize a dischargeable ink quantity of the container 78a. In a case where the motor 80a is a servo motor or a stepping motor, the phase sensor 86a may not be necessary.

In this embodiment, the motor 80a is a drive source that rotates the rotor 76a, which is a non-limiting example. Instead, an air rotary actuator may be used to rotate the rotor 76a. The air rotary actuator is rotated by blowing compressed air against a windmill. In a case where the drive source is such an air rotary actuator, a vane wheel may be installed in the rotor 76a to feed the rotor 76a with compressed air, instead of coupling the drive source and the rotor 76a using the shaft 82a. The drive source for rotating the rotor 76a may be an ink-feeding force. Instead of the motor 80a, the rotor 76a may be rotated by a linearly movable solenoid and a conversion mechanism that converts the linear movement into a rotary motion. Examples of the conversion mechanism may include a rack-and-pinion mechanism and a crank mechanism. In a case where the solenoid and the conversion mechanism, which are both drive sources, are used instead of the drive source and the rotor 76a coupled with the shaft 82a, the conversion mechanism may convert the reciprocatory linear motion of the solenoid into a rotary motion and directly rotate the rotor 76a.

This embodiment provides four containers 78a formed at equal intervals on the outer periphery of the rotor 76a. The number of the containers 78a may not necessarily be four but may be at least one. Optionally, the rotor 76a may have five or more containers 78 so as to increase the number of ink discharges per one rotation of the rotor 76a. This may further improve the dispenser 30a in responsiveness to the discharge control.

The semi-spherical shape of the container 78a according to this embodiment is a non-limiting example. The container 78a may have a semi-elliptical shape, a polyhedron shape, a cylindrical shape, a conical shape, or a frustum shape.

In this embodiment, the container 78a is a recess having an opening toward the outer peripheral surface of the rotor 76a, which is a non-limiting example. As illustrated in FIG. 9, containers 178a are in the form of passages each connected to two openings 100a formed on the outer peripheral surface of the rotor 76a. Thus, the ink containers 178a of the rotor 76a may be provided with plural openings. In this instance, the ink may flow into the container 178a through one of the two openings 100a and out of the container 178a through the other opening 100a, or the ink may flow in and out through the same opening.

In this embodiment, the temperature adjuster 55a is disposed in the ink tank 52a to adjust the temperature of the ink 54a stored in the ink tank 52a. Instead, the temperature adjuster 55a may directly or indirectly adjust the inner walls of the containers 78a in temperature to be near or equal to the target temperature. The temperature adjuster 55a may be disposed in at least one of the ink flow path 56a and the casing 62a.

In this embodiment, the O-rings 74a are used to seal the gap between the casing 62a and the rotor 76a. The gap between the casing 62a and the rotor 76a may be sealed otherwise, for example, a labyrinth seal may be applied to at least one of opposing faces of the casing 62a and the rotor 76a. In a case where adjustments are possible to lose or minimize any gap between the casing 62a and the rotor 76a, the O-rings 74a and the sealing grooves 72a may be unnecessary. Without the O-rings 74a, replacement of O-rings due to wear can be dispensed with. This may facilitate and improve maintenance of the dispenser 30a. Without the sealing grooves 72a, the dispenser 30a may be structurally simplified and manufactured with lower cost.

In this embodiment, the ink discharged from the dispenser 30a is an ultraviolet-curable ink, but may be selected from any liquid materials that can be discharged from the dispenser 30a, for example, adhesives, resins, liquid crystal materials, metallic nanoparticle-containing inks, and creamy solders.

In this embodiment, the liquid supply channel 68a is formed at the uppermost part of the upper casing 64a. The liquid supply channel 68a may be forming otherwise, for example, at a position that allows the liquid supply channel 68a and the container 78a to intercommunicate when the rotor 76a is rotated. The liquid supply channel 68a may be formed at a position on a side surface of the casing 62a.

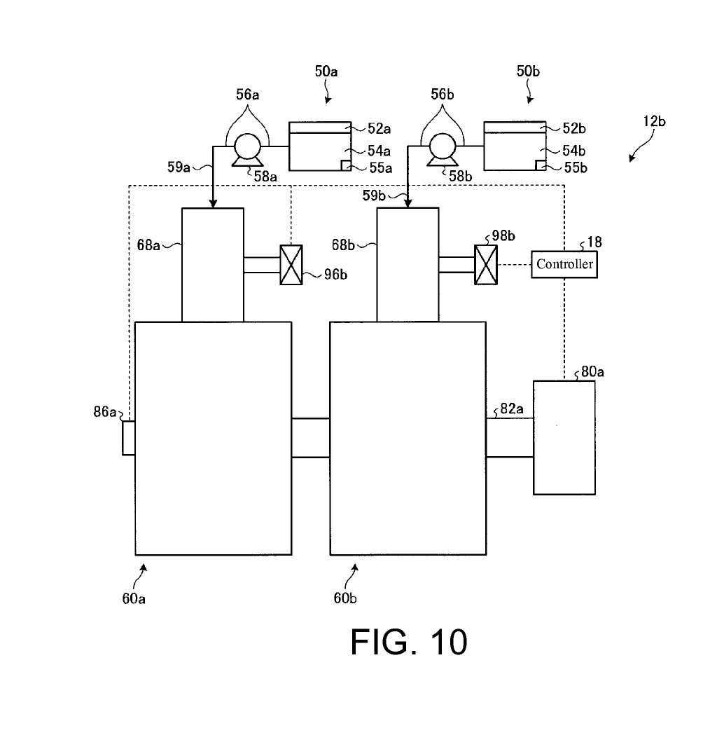

Referring to FIG. 10, a dispenser unit 12b according to a second embodiment is hereinafter described. FIG. 10 is a schematic block diagram of the dispenser unit 12b according to the second embodiment. The dispenser unit 12b according to the second embodiment may be used in the three-dimensional object forming apparatus 10 in place of the dispenser unit 12a according to the first embodiment. Except the dispenser unit 12b, the three-dimensional object forming apparatus according to the second embodiment is basically the same as the three-dimensional object forming apparatus 20.

The dispenser unit 12b has a high-pressure liquid feeder 50a, a second high-pressure liquid feeder 50b, a discharger 60a, a second discharger 60b, a motor 80a, and electromagnetic valves 96b, 98b. The dispenser unit 12b is basically the same as the dispenser unit 12a except that the dispenser unit 12b has the second discharger 60b in addition to the discharger 60a, the second high-pressure liquid feeder 50b in addition to the high-pressure liquid feeder 50a, and the electromagnetic valves 96b, 98b. The same components as those in the dispenser 30a are indicated with the same reference components and will not be described again in detail.

The second discharger 60b is configured similarly to the discharger 60a. As illustrated in FIG. 10, the second discharger 60b, as well as the discharger 60a, is attached to the shaft 82a.

The second high-pressure liquid feeder 50b feeds the second discharger 60b with the ink. Otherwise, this feeder 50b is configured similarly to the high-pressure liquid feeder 50a.

As illustrated in FIG. 10, the electromagnetic valve 96b is attached to the liquid supply channel 68a of the discharger 60a. The electromagnetic valve 96b is coupled to the controller 18. The electromagnetic valve 96b closes the liquid supply channel 68a in response to a closing signal inputted from the controller 18 to block the high-pressure ink 59a flowing from the high-pressure liquid feeder 50a. The electromagnetic valve 96b opens the liquid supply channel 68a in response to an opening signal inputted from the controller 18 to invite the flow of the high-pressure ink 59a from the high-pressure liquid feeder 50a.

As illustrated in FIG. 10, the electromagnetic valve 98b is attached to a liquid supply channel 68b of the second discharger 60b. The electromagnetic valve 98b is coupled to the controller 18. The electromagnetic valve 98b closes the liquid supply channel 68b in response to a closing signal inputted from the controller 18 to block a high-pressure ink 59b flowing from the second high-pressure liquid feeder 50b. The electromagnetic valve 98b opens the liquid supply channel 68b in response to an opening signal inputted from the controller 18 to invite the flow of the high-pressure ink 59b from the second high-pressure liquid feeder 50b.

The operation of the dispenser unit 12b according to the second embodiment is hereinafter described. In the dispenser unit 12b according to the second embodiment, ink-discharge operations of the discharger 60a and the second discharger 60b of the dispenser unit 12b are basically the same as in the dispenser 30a according to the first embodiment in any aspect but opening and closing of the electromagnetic valves 96b, 98b. Description of these operations, therefore, is omitted.

To suspend the ink-discharge operations of the discharger 60a and the second discharger 60b, the controller 18 closes the electromagnetic valves 96b, 98b and suspends the rotation of the motor 80a. To have the discharger 60a and the second discharger 60b both discharge the ink at once, the controller 18 opens the electromagnetic valves 96b, 98b and rotates the motor 80a. To suspend the ink discharge of the discharger 60a, while allowing the second discharger 60b to discharge the ink, the controller 18 closes the electromagnetic valve 96b but opens the electromagnetic valve 98b and rotates the motor 80a. To suspend the ink discharge of the second discharger 60b, while allowing the discharger 60a to discharge the ink, the controller 18 opens the electromagnetic valve 96b but closes the electromagnetic valve 98b and rotates the motor 80a. In the dispenser unit 12b, the controller 18 controls the ink-discharge operations of the discharger 60a and the second discharger 60b by opening and closing the electromagnetic valves 96b, 98b. There is a time lag of at least half a cycle until the ink discharge stops after at least one of the electromagnetic valves 96b, 98b is closed when the motor 80a is rotating. The liquid supply channel 68a is formed at the uppermost part of the casing 62a, and the discharge nozzle 70a is formed on the lowermost surface of the casing 62a. The high-pressure ink 59a, which is supplied to the container 78a by the time when the rotor 76a rotates through at least 180 degrees, continues to be discharged through the discharge nozzle 70a even after closure of the electromagnetic valve 96b. A cycle described herein refers to time required for the motor 80a to rotate through 360 degrees.

The dispenser unit 12b according to the second embodiment has the second discharger 60b in addition to the discharger 60a, which are both coupled to the shaft 82a. By rotating one motor 80a, the discharger 60a and the second discharger 60b are allowed to discharge the ink at once.

The dispenser unit 12b according to the second embodiment has the electromagnetic valves 96b, 98b. These electromagnetic vales may allow for blockage of the ink that flows out of the high-pressure liquid feeder 50a and the second high-pressure liquid feeder 50b into the discharger 60a and the second discharger 60b. Therefore, any leakage of the ink from the discharger 60a and the second discharger 60b may be prevented.

The dispenser unit 12b according to the second embodiment has the second discharger 60b and the discharger 60a that are both coupled to the shaft 82a, and has the electromagnetic valves 96b, 98b coupled to the controller 18. The controller 18, by opening and closing the electromagnetic valves 96b, 98b, may allow one of the discharger 60a and the second discharger 60b to selectively discharge the ink.

In this embodiment, the second discharger 60b, as well as the discharger 60a, is coupled to the shaft 82a, and the electromagnetic valves 96b, 98b are coupled to the respective dischargers. The numbers of dischargers and electromagnetic valves coupled to the dischargers may optionally be decided, and for example, there may be eight dischargers and electromagnetic valves.

What is claimed is:

1. A dispenser, comprising:
a high-pressure liquid feeder that feeds a high-pressure liquid higher in pressure than atmospheric pressure;
a discharger that discharges the high-pressure liquid fed from the high-pressure liquid feeder; and
a drive source that drives the discharger to operate,
wherein the discharger comprising:
at least a container in which the high-pressure liquid is containable, the container being formed on an outer peripheral surface of the discharger;
a rotor rotatable by the drive source;
a casing in which the rotor is housed in a rotatable manner, the casing including a liquid supply channel formed to intercommunicate the container and the high-pressure liquid feeder, and a discharge nozzle formed to intercommunicate the container and outside of the discharger; and
a controller configured to control rotation of the drive source and a position of the container in a direction of the rotation of the drive source.

2. The dispenser according to claim 1, further comprising:
a phase sensor that measures a rotational phase of the drive source,
wherein the controller controls the rotation of the drive source based on a result of detection by the phase sensor to control the position of the container.

3. The dispenser according to claim 1, further comprising:
a temperature adjuster that adjusts a temperature of a surface of the container that makes contact with the high-pressure liquid.

4. The dispenser according to claim 1, wherein
the drive source is one of a stepping motor and a servo motor.

5. A dispenser unit, comprising:
a plurality of the dispensers according to claim 1,
wherein a plurality of the dischargers in the plurality of the dispensers are coupled to the drive source.

6. The dispenser unit according to claim 5, further comprising:
electromagnetic valves attached to the liquid supply channels in the plurality of the dispensers,
wherein the controller opens and closes the electromagnetic valves to control feed of an ink to the plurality of the dispensers.

7. An apparatus for forming a three-dimensional object based on a shape-related information of the three-dimensional object, comprising:
the dispenser according to claim 1;
a table on which the three-dimensional object is formable;
an ultraviolet light source that irradiates the three-dimensional object with ultraviolet light; and
a driver that moves the table and the dispenser relative to each other,
wherein the controller controls operation of the driver and rotation of the drive source based on the shape-related information of the three-dimensional object.

8. An apparatus for forming a three-dimensional object based on a shape-related information of the three-dimensional object, comprising:
the dispenser according to claim 2;
a table on which the three-dimensional object is formable;
an ultraviolet light source that irradiates the three-dimensional object with ultraviolet light; and
a driver that moves the table and the dispenser relative to each other,
wherein the controller controls operation of the driver and rotation of the drive source based on the shape-related information of the three-dimensional object.

9. An apparatus for forming a three-dimensional object based on a shape-related information of the three-dimensional object, comprising:
the dispenser according to claim 3;
a table on which the three-dimensional object is formable;
an ultraviolet light source that irradiates the three-dimensional object with ultraviolet light; and
a driver that moves the table and the dispenser relative to each other,
wherein the controller controls operation of the driver and rotation of the drive source based on the shape-related information of the three-dimensional object.

10. An apparatus for forming a three-dimensional object based on a shape-related information of the three-dimensional object, comprising:
the dispenser according to claim 4;
a table on which the three-dimensional object is formable;
an ultraviolet light source that irradiates the three-dimensional object with ultraviolet light; and
a driver that moves the table and the dispenser relative to each other,
wherein the controller controls operation of the driver and rotation of the drive source based on the shape-related information of the three-dimensional object.

11. An apparatus for forming a three-dimensional object based on a shape-related information of the three-dimensional object, comprising:
the dispenser unit according to claim 5;
a table on which the three-dimensional object is formable;
an ultraviolet light source that irradiates the three-dimensional object with ultraviolet light; and
a driver that moves the table and the dispenser unit relative to each other,
wherein the controller controls operation of the driver and rotation of the drive source based on the shape-related information of the three-dimensional object.

12. An apparatus for forming a three-dimensional object based on a shape-related information of the three-dimensional object, comprising:
the dispenser unit according to claim 6;
a table on which the three-dimensional object is formable;
an ultraviolet light source that irradiates the three-dimensional object with ultraviolet light; and
a driver that moves the table and the dispenser unit relative to each other,
wherein the controller controls operation of the driver and rotation of the drive source based on the shape-related information of the three-dimensional object.
